(19) United States
(12) Patent Application Publication
(10) Pub. No.: US 2023/0322588 A1
(43) Pub. Date: Oct. 12, 2023

(54) Electrochemical Oxidation of Amine Complexants in Waste Streams from Electroplating Processes

(71) Applicant: MacDermid, Incorporated, Waterbury, CT (US)

(72) Inventor: Trevor Pearson, Cradley Heath (GB)

(21) Appl. No.: 17/716,524

(22) Filed: Apr. 8, 2022

(51) Int. Cl. C02F 1/461

(52) U.S. Cl. CPC C02F 1/46109; C02F 2101/18

(57) ABSTRACT

A process of treating a waste stream comprising organic amine compounds complexed with heavy metal ions. The process includes the steps of: (1) adjusting the pH of the waste stream to between about 4 and about 10; (2) b) adding a chloride salt to the waste stream to produce a concentration of chloride ions in the waste stream; and (3) circulating the waste stream through an electrochemical reactor. The electrochemical reactor comprises an array of electrodes comprising alternating anodes and cathodes. The waste stream is circulated through the electrochemical reactor for a period of time sufficient to hydrolyse amine compounds in the waste stream.

### FIELD OF THE INVENTION

The present invention relates generally to the treatment of waste produced in electroplating processes.

### BACKGROUND OF THE INVENTION

In the metal finishing industry, plating used for electrolytic and electroless plating of metal and metal alloys generally contain metal ions of the desired metal to be plated along with various complexants (i.e., chelating agents) and other bath constituents. Depending on the metal(s) to be plated, these complexants may include, for example, ethylenediamine tetraacetic acid (EDTA), aminopolycarboxylic acids such as nitriloacetic acid (NTA), cyanides, polyamines, and other complexants that are capable of creating strong bonds.

While the use of such complexants aids in producing a desirable plated deposition on a substrate, disposal of these compounds and their by-products can be problematic and costly and can, in some cases, inhibit the ability of a wastewater treatment plant to meet required discharge limits.

Examples of industrial wastewater include a variety of spent electroless bath and electroplating baths, including for example, cyanide copper plating wastewater, pyrophosphate copper plating wastewater, acid copper plating wastewater, bright nickel plating wastewater, potassium chloride zinc plating wastewater, alkaline non-cyanide zinc plating wastewater, cyanide initiation gold copper-zinc alloy electroplating wastewater, gun-color tin-nickel alloy electroplating wastewater, alkaline zinc-nickel alloy electroplating wastewater, acidic zinc-nickel alloy electroplating wastewater, hexavalent chromium plating wastewater, trivalent chromium plating wastewater, electroless nickel plating wastewater, electroless copper plating wastewater, hexavalent chromium passivation wastewater, trivalent chromium passivation wastewater, degreasing wastewater, pickling wastewater, among others, which may be present in the wastewater alone or in combination. The industrial wastewaters typically contain complexants (i.e., sodium cyanide, potassium pyrophosphate, sodium citrate, sodium potassium tartrate, sodium malate, diethylene triamine, hydroxyl-containing organic amines, etc.), heavy metal ions (i.e., copper, nickel, zinc, cobalt, hexavalent chromium, trivalent chromium, etc.), and other pollutants (i.e., sodium phosphate, sodium hypophosphite, brighteners, auxiliary brighteners, surfactants, etc.).

Depending upon the nature of the industrial wastewater produced and the degree of metal removal desired, various wastewater treatment options can be used. However, if the industrial wastewater contains strong complexants such as EDTA and/or polyamines, conventional treatment options, including precipitation of metal ions, can be inadequate.

Examples of conventional options for treating industrial wastewaters include, but are not limited to, (1) hydroxide precipitation of metals; (2) use of an iron reagent; and (3) the use of dimethyl dithiocarbamate.

Hydroxide precipitation of metals is widely used due to its simplicity of use and relatively inexpensive costs. However, hydroxide precipitation is generally ineffective in breaking down complexing bonds produced by various complexants. That is, sodium hydroxide will react with any non-chelated heavy metal present to produce an insoluble metal hydroxide. However, co-precipitation with other metals as cations can yield lower solubility. In addition, certain complexants are specifically designed to prevent hydroxide precipitation from occurring under normal conditions.

Iron can be used in the presence of complexants to break down a number of complexant bonds. An iron reagent is introduced in the wastewater in a sufficient amount to reduce most metals and break complexants bonds. The iron reagent is added to the solution in a first reaction tank at a pH of about 2.0 to 3.0 and the solution is then raised go a pH of between 8.5 and 11 in a second reaction tank, where the metals, including iron, precipitate as metal hydroxides. One of the primary disadvantages of the iron reagent chemistry is that the reagent is added on a volumetric basis, and the dosage must therefore be predetermined and is not related to the actual concentration of metals in the feed. Thus, the iron reagent process can be very difficult to optimize and control when there are wide fluctuations in feed metal concentrations.

Dimethyl dithiocarbamate (DTC) can be used in the presence of most (if not all) chelating agents. DTC reacts with metals to form an insoluble metal/DTC compound which will precipitate as sludge. The concentration of the chelated material has a significant impact on the dosage rate. So, one significant disadvantage of the DTC process is that it cannot be easily and safely adjusted to treat fluctuations in feed metal concentrations. However, the DTC process does produce less sludge than the corresponding iron reagent process.

While these treatment options have seen success in treating industrial wastewaters, including electroless plating and electroplating wastewaters, these treatment options have difficulty in treating industrial wastewaters containing complexants such as polyamines in an efficient and cost effective manner. There remains a need in the art for treatment methods for use in treating industrial wastewaters that can break down complexants, including amine-based complexants. In addition, there remains a need in the art for improved treatment methods for treating alkaline zinc-nickel electroplating waste streams containing amine complexed-metal ions and electroless copper waste streams for subsequent disposal. It would also be desirable to develop a process of treating electroplating wastewater containing complexants such as EDTA and amine-based complexants complexed with heavy metal ions and that can be used in combination with conventional methods of precipitating heavy metal ions and mixtures of heavy metal ions.

For a number of years, the automotive industry has relied on the production of fasteners and other fabricated steel parts which are coated with an alloy of zinc and nickel by electroplating. Typically, the alloy is primarily of zinc with a nickel content of between 12-15%. These alloys have good corrosion resistance and corrosion products are compact and do not significantly detract from the cosmetic appearance of the finished articles. Zinc-nickel alloys also exhibit favourable contact corrosion properties when in contact with aluminium. Due to the prevalence of extended corrosion warranties on modern cars, the use of zinc nickel plated components has become essential.

There are two main processes typically used for the deposition of zinc nickel alloys, depending in part on the type of component being plated.

For cast iron components such as brake cylinders, processes which are close to a neutral pH are used. These processes typically have a pH of around 5 and are referred to as “acid zinc nickel” solutions. In order to buffer the solution pH at the electrode/electrolyte interface and prevent the co-deposition of metal hydroxides due to the rise in pH at the cathode during electrolysis (due to the reduction of hydrogen ions), ammonium ions are used in the electrolyte. Ammonium ions become a problem in waste treatment because as the pH of the waste stream is raised in order to precipitate metal ions from solution as metal hydroxides, the ammonium ions lose a proton to become ammonia. This can act as a ligand, which renders the nickel ions soluble thus preventing precipitation.

For other components, including fasteners and other fabricated steel parts, alkaline zinc nickel processes are often used. This is because alkaline processes are far easier to operate and produce a much more even alloy composition over a wide range of current densities than typical acid processes. However, unlike acid processes, which rely on the use of ammonium ions as a pH buffer, the use of organic amines is essential in alkaline zinc nickel processes to render the nickel ions soluble. Ammonia is not suitable for this purpose because it is volatile at the operating pH and does not produce complexes with the required kinetic and thermodynamic properties for the process.

Typical alkaline zinc nickel electroplating baths contain metal ions in combination with amine-based complexants, along with other bath constituents added to obtain desired plating characteristics. Various alkaline zinc-nickel plating electrolytes are known in the art and are described, for example, in U.S. Pat. Pub. No. 2008/0223726 to Eckles et al., U.S. Pat. Pub. No. 2006/0201820 to Opaskar et al., U.S. Pat. No. 7,442,286 to Capper et al., U.S. Pat. Pub. No. 2010/0096274 to Rowan et al., and U.S. Pat. Pub. No. 2020/0263314 to Niikura et al., the subject matter of each of which is herein incorporated by reference in its entirety.

A typical alkaline zinc-nickel electroplating bath contains about 0.5 to about 50 g/L nickel ions, about 0.1 to about 100 g/L zinc ions, and about 5 to about 100 g/L of a complexant, which is typically an amine based complexant. In addition, the electroplating bath also typically includes an inorganic alkaline component in a sufficient quantity to provide the bath with the desired pH. For example, the inorganic alkaline component may be present at a concentration of between about 50 to about 220 g/L to provide a bath having a pH of at least about 10, or at least about 11 or at least about 14. The inorganic alkaline component is typically an alkali metal derivative such as sodium or potassium hydroxide, but alternatively may comprise sodium or potassium carbonate or sodium or potassium bicarbonate. Mixtures of the inorganic alkaline component may also be used.

Examples of amine complexants usable in alkaline zinc nickel electroplating baths include alkylene amine compounds such as ethylenediamine, diethylenetriamine, triethylenetetramine, tetraethylenepentamine, and pentaethylenehexamine; alkylene oxide adducts such as ethylene oxide adducts and propylene oxide adducts of the above alkylene amines; aminoalcohols such as ethanolamine, diethanolamine, triethanolamine, diisopropanolamine, triisopropanolamine, ethylenediamine tetra-2-propanol, N-(2-aminoethyl)ethanolamine, and 2-hydroxyethylaminopropylamine; alkanolamine compounds such as N-(2-hydroxyethyl)-N,N′,N′-triethylethylenediamine, N,N′-di(2-hydroxyethyl)-N,N′-diethylethylenediamine, N,N,N′,N′-tetrakis(2-hydroxyethyl)propylenediamine, and N,N,N′,N′-tetrakis(2-hydroxypropyl)ethylenediamine (available under the tradename Quadrol®); poly(alkylene imine)s obtained from ethylene imine, 1,2-propylene imine, and the like; and poly(alkylene amine)s obtained from ethylene diamine, triethylene tetramine, and the like. The complexant may comprise one or more selected from the group consisting of alkylene amine compounds, alkylene oxide adducts thereof, and alkanolamine compounds. These amine complexants may be used alone or in combinations of two or more. In the case of electroless copper plating baths, EDTA is a common complexant.

Amine complexants in the wastewater generally cannot be effectively removed using conventional oxidation processes, resulting in difficulty in treatment of the electroplating wastewater. A typical alkaline zinc-nickel alloy electroplating bath may contain about 3% by weight of the amine complexing agent, which has high stability, and cannot be effectively broken down by typical wastewater treatment methods.

WO2019/085128 to Guangzhou Ultra Union Chemicals Ltd. discloses a method for treating alkaline zinc-nickel alloy electroplating wastewater that includes the multiple steps of adjusting the pH of the alkaline zinc-nickel alloy electroplating wastewater and adding various reagents including sodium diethyldithiocarbamate, a flocculant, and sodium hypochlorite. Similarly, US2021/0380455 to Guo et al., the subject matter of which is herein incorporated by reference in its entirety, describes a method for treatment of mixed electroplating wastewater without a cyanide and a phosphorus-containing reducing agent without a cyanide and in which aliphatic polyamine complexants are destroyed using a biological degradation technique to reduce chemical oxygen demand (COD). However, the biological degradation technique typically requires a time of 8-24 hours to reach an acceptable level of COD, in addition to the multiple additional steps required in the process to treat the wastewater so that it is sufficiently free of contaminants prior to discharge.

Other treatment methods, such as described in CN103641207A, rely on the use of a composite electrolytic cell for electrolysis of zinc-containing electroplating wastewaters.

Because nickel anodes cannot be used in alkaline zinc nickel electroplating processes, all of the nickel which is plated out is added as a nickel salt (such as nickel sulphate or nickel chloride). However, this salt cannot be simply added to the electroplating bath because it will not dissolve in the alkaline environment. Instead, it must be pre-complexed beforehand using one or more of the amine complexants described above. Thus in use, the electroplating bath will build up in both amine complexants and a salt (i.e., sodium sulphate or chloride or potassium sulphate or chloride (depending on the process formulation)). This typically must be controlled by periodically removing a portion of the plating bath or by using a “feed and bleed” system, which creates a large amount of waste in addition to the usual “drag out” losses. Because the alkaline zinc-nickel electroplating system is widely used, the problem of waste treatment is substantial.

As described above, the waste from these alkaline zinc nickel electroplating processes cannot be effectively treated and must be taken away for incineration, which is expensive and wasteful of energy.

Some electroplating companies attempt to remove nickel from the waste by precipitating the nickel using dimethylglyoxime as described, for example, in U.S. Pat. No. 4,500,325 to Vuong, the subject matter of which is herein incorporated by reference in its entirety. This produces an insoluble nickel complex which can be filtered out. However, this process still leaves the amine complexants behind in solution, so the waste solution cannot be mixed with other waste streams and in many cases cannot be safely discharged into the environment due to the toxicity of the amine compounds to fish and other aquatic species. In some circumstances, large quantities of sodium hypochlorite solution may be added in order to react with the amine groups in the complexants present in the waste stream. However a large excess of sodium hypochlorite is required, which leads to further waste treatment issues and the development of large quantities of sludge.

Organic amines are also used as complexants in other processes in the metal finishing industry. For example, the printed circuit industry utilises electroless copper plating processes which contain organic amine complexants (for example Quadrol® and EDTA).

Thus, it would be desirable to provide a method for the removal of amine complexants from industrial process wastewater that overcomes the deficiencies of the prior art.

### SUMMARY OF THE INVENTION

In one embodiment, the present invention describes a method of removing organic amine complexants from industrial electroplating waste using a chloride-mediated electrochemical oxidation process. The process utilises anodes electrodes which are insoluble in the wastewater at the applied potential and that have a high oxygen overpotential and a low chlorine overpotential.

Following the electrolytic treatment to remove organic amine complexants, the wastewater can be further treated to remove metals such as zinc and nickel from the waste stream.

### BRIEF DESCRIPTION OF THE DRAWINGS

FIG. 1 depicts a graph of showing the comparative rates of amine decomposition for Examples performed in accordance with the invention.

### DETAILED DESCRIPTION OF THE PREFERRED EMBODIMENTS

As used herein, “a,” “an,” and “the” refer to both singular and plural referents unless the context clearly dictates otherwise.

As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform herein. Furthermore, it is also to be understood that the value to which the modifier “about” refers is itself specifically disclosed herein.

As used herein, spatially relative terms, such as “beneath”, “below”, “lower”, “above”, “upper” and the like, are used for ease of description to describe one element or feature's relationship to another element(s) or feature(s) as illustrated in the figures. It is further understood that the terms “front” and “back” are not intended to be limiting and are intended to be interchangeable where appropriate.

As used herein, the terms “comprises” and/or “comprising,” specify the presence of stated features, integers, steps, operations, elements, and/or components, but do not preclude the presence or addition of one or more other features, integers, steps, operations, elements, components, and/or groups thereof.

As used herein the term “substantially-free” or “essentially-free” if not otherwise defined herein for a particular element or compound means that a given element or compound is not detectable by ordinary analytical means that are well known to those skilled in the art of metal plating for bath analysis. Such methods typically include atomic absorption spectrometry, titration, UV-Vis analysis, secondary ion mass spectrometry, and other commonly available analytically methods.

The terms “plating” and “electroplating” are used interchangeably throughout this specification.

As used herein, the term “immediately” means that there are no intervening steps.

The present invention relates generally to the use of electrochemical oxidation to at least substantially remove strong complexants, such as EDTA and amine-based complexants, from industrial process waste including, for example, spent alkaline zinc nickel electroplating baths and spent electroless copper plating baths. The process described herein can also substantially remove any cyanide present in the electroplating bath, whether as an additive or as a by-product.

The process of oxidation involves the removal of electrons from the reactant which is being oxidised. This can theoretically be achieved by electrochemical oxidation where a power source is used to directly remove electrons from molecules in contact with the anode (the charge is balanced by the provision of electrons to other molecules in contact with the cathode). This method is advantageous for waste treatment because it adds no new molecules to the waste stream (compared to chemical oxidation) and, can utilise electricity from renewable sources. Thus, the method describe in the present invention has the possibility of operating in an environmentally acceptable manner.

The inventors have found that the use of electrochemical oxidation is complicated and there are many difficulties that must be overcome in order to successful use electrochemical oxidation for the treatment of strong complexants in the waste stream. These can be summarised as follows:
1) Because the reaction occurs at the electrode surface (i.e., it is a heterogeneous reaction), the rate of oxidation is limited by the rate of mass transport of the molecule to be oxidised to the electrode surface.
2) The electrode must be composed of a material that has sufficient affinity for the molecule to be oxidised to allow specific adsorption of the molecule so that electron transfer reactions can occur (through a mechanism of quantum mechanical tunnelling).
3) The material composing the electrode must be incapable of being oxidised itself at the electrode potential being used in the electrochemical oxidation process.
4) The molecule to be oxidised must be capable of being oxidised at lower potential than that required to oxidise water (this is because zinc nickel waste streams contain mostly of water).
5) The reaction products from the oxidation process must not “poison” the electrode. Poisoning of the electrode is caused by adsorption of species on the surface of the electrode that prevent further adsorption of the molecules that need to be oxidised.

Studies related to the electrochemical oxidation of ammonia in waste streams have determined that during the oxidation process, atomic nitrogen produced as an intermediate species remains adsorbed on the electrodes and poisons the further oxidation of ammonia thus dramatically limiting the efficiency of the oxidation of ammonia.

The inventors of the present invention have found that this “poisoning” of the electrode surface is also very pronounced if organic amines are attempted to be oxidised in this manner.

It is known that in the case of ammonia in waste streams, the inclusion of chloride ions can prevent this poisoning reaction. However, the reaction mechanism for the oxidation of polyamines and other such strong complexants cannot be explained by the reaction mechanisms proposed for the oxidation of ammonia.

Based thereon, this reaction mechanism has also not been tried in systems containing amine complexes with heavy metal ions in which the amine complexant must be separated from the heavy metal ions to allow for disposal of the amine complexant and heavy metal ions separately in an efficient manner. In addition, this method has also not been applied to organic amine-based complexants as the reaction mechanisms for the oxidation of ammonia are different from the reaction mechanisms for the treatment/oxidation of organic amines.

The inventors of the present invention have found that the organic amines present in zinc nickel waste streams can be electrochemically oxidised by utilising chloride ions as an intermediate species to oxidise the amines. That is, the inventors of the present invention have discovered a process for treating organic amines present in industrial process waste streams that uses electrochemical oxidation to oxidize EDTA and amine-based complexants in the waste streams. The process can also oxidize any cyanide compounds present in the waste stream.

In one embodiment, the present invention relates generally to a process of treating a waste stream comprising organic amine compounds complexed with heavy metals, the process comprising the steps of:
a) adjusting the pH of the waste stream to between about 4 and about 10;
b) adding a chloride salt to the waste stream to produce a concentration of chloride ions in the waste stream;
c) circulating the waste stream through an electrochemical reactor, wherein the electrochemical reactor comprises an array of electrodes comprising alternating anodes and cathodes;
   wherein the waste stream is circulated through the electrochemical reactor for a sufficient time to hydrolyse the organic amine compounds in the waste stream.

The hydrolysis of the amines occurs after the initial oxidation reaction with hypochlorous acid formed at the anode from the electrolytic oxidation of chloride ions.

Thereafter, the waste stream containing the reaction products of the hydrolysed amine compounds and heavy metal ions may be subjected to a step of treating the waste stream to remove the heavy metal ions, such as by precipitating the heavy metal ions from the waste stream. Thereafter, the waste stream may be subjected to further treatment steps, if necessary, prior to discharge.

Without wishing to be bound by theory, it is believed that the following mechanistic considerations are the most likely manner in which the electrochemical oxidation described in the present invention operates:

### Anodic Reactions

Chloride ions can be anodically oxidised by the following reaction:

2Cl^{-→Cl}₂+2e⁻ Eₒ=+1.36V vs NHE (1)

The chlorine formed by this reaction then reacts with water to form hypochlorous acid:

Cl₂+H₂O→HOCl+HCl (2)

At the potential at which chloride ions are oxidised, there is a competing oxidation process producing oxygen:

2H₂O→O₂+4H⁺+4e⁻ Eₒ=+1.229V vs NHE (3)

However, as this reaction involves the liberation of oxygen gas, there will be a fairly large oxygen overpotential to add to the standard potential. This is because the standard potential is an equilibrium potential where there is no overall liberation of gas. In order to liberate gas, an additional voltage is required to supply the activation energy. Typically, overpotentials for chlorine evolution are lower than those for oxygen evolution.

Typical overpotentials for oxygen and chlorine at electrodes commonly used for this purpose are as follows:
Platinized electrodes: Chlorine +0.08V Oxygen +0.46V
Mixed metal oxide electrodes: Chlorine −0.06V Oxygen +0.32V
Graphite Chlorine +0.12V Oxygen +0.50V

All of these electrodes preferentially produce chlorine rather than oxygen in a chloride containing environment. However, graphite anodes tend to have a short lifetime as a chlorine generating anode so have largely been replaced by mixed metal oxide coated anodes. These are very efficient at liberating chlorine due to their catalytic effect of so it is possible in some circumstances to obtain chlorine evolution slightly below the standard potential.

### Reactions of Hypochlorous Acid

Hypochlorous acid will react quickly with amines forming chloramines as exemplified by the following reactions:

R—NH₂+HOCl→R—NHCl+H₂O Primary amine (4)

R₂—NH+HOCl→R₂NCl+H₂O Secondary amine (5)

R₃—N+HOCl→R₂NCl+ROH Tertiary amine (6)

These chloramines are not stable and are hydrolysed in the presence of chlorine or hypochlorous acid to nitrogen (or to a lesser extent nitrate) and other organic moieties. Once this process is complete, the resultant mixture is no longer capable of chelating metal ions. Thus, the resulting heavy metal ions and hydrolysed reaction products can be processed or disposed of separately.

Examples of the decomposition process are given below:

3R—NHCl+2H₂O→N₂+3Cl⁻+3H⁺+R—NH₂+2ROH (7)

3NR₂Cl+4H₂O→R₂NH+N₂+4ROH+3H⁺+3Cl⁻ (8)

Electrochemical oxidation proceeds via a stepwise mechanism to remove amines from the waste stream and the nitrogen species in solution are eventually converted to nitrogen gas. The oxidation of organic amines also produces organic alcohols which may undergo further oxidation to aldehydes and carboxylic acids. Chloride ions, which initially oxidised to form hypochlorous acid, are regenerated during the decomposition of the chloramines to act as a catalyst for the decomposition.

During the zinc nickel plating process, some of the amines are partially oxidised to cyanide ions and these can be problematic in waste streams. However, cyanide can also be electrochemically oxidised in the presence of chloride ions which have been oxidised to hypochlorous acid according to the following reactions:

HOCl+OH⁻→OCl⁻+H₂O (9)

CN⁻+OCl⁻→CNO⁻+Cl⁻ (10)

CNO⁻+3H₂O→NH₃+HCO₃⁻ Catalysed by chlorine/hypochlorous acid (11)

6ClO⁻+2NH₃→N₂+6H₂O+6Cl⁻ (12)

### Cathodic Reactions

The primary cathodic reaction is the reduction of water to hydrogen gas and hydroxide ions as follows:

2H₂O+2e⁻→H₂+2OH⁻ Eₒ=−0.8277 V vs NHE (13)

There may be some side reaction of metal reduction. However, this is likely to be negligible in view of the low concentration of metal ions in the waste stream. The hydroxide ions produced at the cathode will neutralise the H⁺ ions produced at the anode. Based thereon, little overall change in the pH of the waste stream during electrolysis is expected.

In the case of treatment of electroless copper waste, some deposition of copper on the cathodes is generally expected, and this would necessitate occasional stripping of the cathodes. Thus, in the case of treating electroless copper waste streams, the use of stainless steel cathodes is generally preferred as the use of such cathodes would facilitate stripping.

As described above, the present invention generally comprises the following steps:
1. Adjusting the pH of the waste stream to be treated to between 4 and 10 and preferably to a pH of 8 to 9.2. At a pH above this range, the hypochlorous acid formed at the surface of the electrode is converted to hypochlorite ions, which is not as effective at oxidizing amines. At a pH below this range, chlorine gas tends to form instead of hypochlorous acid.
2. Adding a chloride salt (preferably sodium or potassium chloride) to the waste stream so that the concentration of chloride ion in the waste stream is between 10 and 50,000 mg/l, preferably between 300 and 3000 mg/l and most preferably between 600 and 1200 mg/l.
3. Passing the waste stream through an electrochemical reactor comprising an array of electrodes which comprises alternating anodes and cathodes. The organic amines in the waste stream are oxidised to species which are not capable of complexing metals (without wishing to be bound by theory, the inventors of the present invention consider that the nitrogenous moieties are oxidised primarily to nitrogen with some secondary oxidation to nitrate). The waste stream is circulated through the array of electrodes within the treatment cell for a sufficient time to oxidize the amine complexants so that the amine complexants decompose to nitrogen. The time period for oxidation is generally on the order of about 30 minutes to about 180 minutes, more preferably about 60 to about 120 minutes.

In one embodiment, the level of decomposition is at least about 50%, preferably at least about 75%, and most preferably at least about 90%.

The contact time to provide sufficient decomposition of the amine compounds will depend on a variety of factors, including, for example, the type of amine compounds, concentration of amine compounds in the waste stream, current density, electrode area, flow rate, and temperature, among others.
4. Optionally, once the amine compounds are hydrolysed to nitrogen, heavy metal ions, such as nickel and zinc ions in the waste stream can be removed from the waste stream by precipitating the nickel and zinc ions or by other means of removal. As noted above, any cyanide compounds in the waste stream are also hydrolysed to nitrogen.

It is noted that the prior art processes generally function to first try to remove metal ions such as zinc and nickel from the waste stream prior to removing complexants from the waste stream by methods such as hydroxide precipitation and DTC processes and have generally been demonstrated to be ineffective because the heavy metals are complexed with the amine compounds and the amine-complexed metal compounds can be broken down for removal and disposal by conventional means.

In contrast, the present invention serves to first hydrolyse/decompose the amine compounds so that they can no longer complex with the metal ions, which makes the removal of both the amine deposition compounds and the metal ions much more efficient. That is, by the process described herein, the steps of first oxidizing and hydrolysing amine compounds followed by precipitation of metal ions from the waste stream results in a waste stream that has fewer waste treatment issues and that does not produce sludge that must be further processed (either by incineration or landfilling).

Preferably, the anodes used in the electrochemical cell may be selected from titanium or niobium coated with either platinum or mixed metal oxides or any combination of iridium oxide, ruthenium oxide or tantalum. The use of other anode materials including, for example, lead dioxide, graphite or boron doped diamond electrodes is also possible. The main consideration is that the electrode material is chosen to have as low a chlorine overpotential as possible and as high an oxygen overpotential as possible. This is to maximise the chlorine generation reaction efficiency.

The material of the cathode is not critical, but is preferred materials include metals having a low hydrogen overpotential. Examples of suitable cathode materials include, for example, mild steel or stainless steel.

The inter-electrode distance (i.e., distance between adjacent anodes and cathodes) should be as short as practical without a possibility of producing short circuits in order to maximise efficiency due to the relatively low electrical conductivity of typical waste streams. The preferred electrode distance is as short as possible within the design parameters of the treatment cell and is typically on the order of about 0.5-20 cm, more preferably about 1-15 cm, more preferably about 2-10 cm. This will minimize the effect of the ohmic resistance of the waste stream and maximize the efficiency of the process. If the electrode distance is too small, there is a possibility of short circuits within the treatment cells if the anodes and cathodes make contact. On the other hand, if the electrode distance is too large, the process will not work in an efficient manner and may not work at all.

The operating current density for the anodes should preferably be between 0.5 and 4 amps per square decimetre (ASD) and most preferably between 1 and 2 ASD. The surface area of each anode is engineered to obtain the required rate of amine oxidation for a particular application.

The electrochemical oxidation process described herein may be performed at a temperature within the range of about 20 to about 40° C., and is more preferably performed at room temperature.

The electrochemical oxidation cell may be subjected to agitation. In some embodiments, agitation of the waste stream is required to achieve good efficiency. Various means of agitation can be used, depending on the degree of agitation required. In one embodiment, agitation is accomplished at least in part by pumping the waste stream through the electrochemical cell.

The invention will now be illustrated in reference to the following non-limiting examples.

### Examples of the Invention

### Example 1

### Oxidation of Diethylenetriamine

Diethylenetriamine contains both primary and secondary amine groups within the same molecule and so is a good test of the process described herein.

An electrolyte was prepared containing:
2 g/l of sodium sulphate;
2 g/l of sodium chloride: and
1 g/l of diethylenetriamine (DETA).

A 250 ml beaker was set up containing a platinised niobium anode of surface area 50 cm² (25 cm² per side) in the centre of the beaker with 2 mild steel cathodes at the sides of the beaker. The electrode separation was approximately 2 cm on either side of the anode. The beaker was also equipped with a magnetic stirrer.

250 ml of the electrolyte was added to the beaker and this was electrolysed at a current of 0.5 A at ambient temperature, corresponding to an anodic current density of 10 mA/cm². The cell voltage was 8.5V.

A 25 ml sample was taken at time intervals of 30 minutes, 1 hour and 2 hours and the beaker was topped up with fresh electrolyte to maintain the level. The sample taken was titrated with 0.05M hydrochloric acid using bromocresol green indicator and the titration value was noted.

The pKa values for the neutralisation of diethylenetriamine are as follows:
pKa1: 4.42
pKa2: 9.21
pKa3: 10.02

Bromocresol green changes colour from blue to yellow. It is blue above pH 5.6 and yellow below pH 4.0, thus a colour change would be expected when 2 out of the three nitrogen containing moieties in the diethylenetriamine were neutralised. Therefore 2M of HCl are equivalent to 1M of DETA.

Titration values were as follows:

| | | | |
|---|---|---|---|
| 0 | minutes | 11.1 ml | Theoretical value 10.8 ml |
| 30 | minutes | 7.0 ml | 36.9% decomposition |
| 1 | hour | 5.2 ml | 53.2% decomposition |
| 2 | hours | 2.9 ml | 73.9% decomposition |

The theoretical current required to decompose 1 g/l DETA @ 100% efficiency=2.14 Ahr/l

Therefore after 30 minutes of electrolysis at 0.5 A in 250 ml, 1 Ahr/l would have been passed so at 100% conversion efficiency, the percentage decomposition would be (1/2.14)×100=46.7% but the actual decomposition value was 36.9% so the conversion efficiency is (36.9/46.7)×100=79.0%

Likewise, after 1 hour of electrolysis, at 100% conversion the percentage decomposition would be (2/2.14)×100=93.5% but the actual decomposition value was 53.2% so the conversion efficiency is (53.2/93.5)×100=56.9%

### Example 2

### Oxidation of Diethylenetriamine in a Larger Cell

The experiment depicted in Example 1 was repeated using a 2 litre volume of the test electrolyte in a larger cell with alternating anodes and cathodes having a total anode area of 300 cm².

A current of 5 amps was applied to the cell, the voltage was 10.6V. Air sparging was used to agitate the solution in the cell rather than magnetic stirring. The anodes used were platinised titanium.

A different method of analysis was used as follows:

A solution was prepared containing an acetate buffer solution of pH 4.5 (2 g/l of sodium acetate and 2 g/l of acetic acid). To this was added 3 g/l of copper sulphate pentahydrate (Solution A). Solutions containing 0.2, 0.4, 0.6, 0.8 and 1.0 g/l of diethylenetriamine were also prepared (Solution B).

10 ml of Solution A was pipetted into a small beaker and 10 ml of Solution B was added and mixed well. The absorbance of this solution at a wavelength of 618 nm (corresponding to the peak absorbance of a scan carried out between 700 and 450 nm) was measured using a Perkin Elmer UV Visible spectrophotometer).

A calibration graph was prepared from the different concentrations of solution B so that the amount of amine in a test solution could be determined in order to evaluate the effectiveness of the test cell. The coefficient of correlation (R²) of the calibration graph was 1 showing excellent linearity.

The results were as follows:

| | | | |
|---|---|---|---|
| 0 | mins | Abs = 0.382 | |
| 30 | mins | Abs = 0.302 | 21.0% decomposition |
| 60 | mins | Abs = 0.248 | 35.1% decomposition |
| 90 | mins | Abs = 0.213 | 44.3% decomposition |
| 120 | min | Abs = 0.181 | 52.7% decomposition |
| 150 | min | Abs = 0.145 | 62.1% decomposition |
| 180 | min | Abs = 0.116 | 69.7% decomposition |

Conversion efficiency at 30 minutes was 37.5%. This is not as high as the conversion efficiency of Example 1, but the rate of agitation in the larger cell was less. This indicates that higher flow rates will produce a more efficient result.

### Example 3

### Oxidation of N,N,N′,N′-tetrakis(2-hydroxypropyl)ethylenediamine (Quadrol®)

Quadrol® is an example of a tertiary amine. The method of Example 2 was repeated with a solution containing:
1 g/l Quadrol®
2 g/l sodium chloride
2 g/l sodium sulphate.

In this example it was observed that the absorption peak occurred at a much higher wavelength than the 618 nm absorption peak recorded for diethylenetriamine.

In the case of Quadrol®, the absorbance peak of the complex was at 753 nm and the extinction coefficient was lower. The analysis method was modified to allow for these differences. The results were as follows:

| | | | |
|---|---|---|---|
| 0 | min | Abs = 0.096 | |
| 30 | min | Abs = 0.076 | 20.8% decomposition |
| 60 | min | Abs = 0.062 | 35.4% decomposition |
| 90 | min | Abs = 0.046 | 52.1% decomposition |
| 120 | min | Abs = 0.033 | 65.6% decomposition |
| 150 | min | Abs = 0.024 | 78.0% decomposition |
| 180 | min | Abs = 0.01 | 89.6% decomposition |

In this experiment, the Quadrol® was decomposed at a higher rate than diethylenetriamine. Without wishing to be bound by theory, it is believed that this may be because Quadrol® only contains 2 amine moieties rather than 3 in the case of diethylenetriamine. This example illustrates that the oxidation process works efficiently for tertiary amines as well as primary and secondary amines.

### Example 4

### Oxidation of Diethylenetriamine using Mixed Metal Oxide Anodes

The method of Example 2 was used except that the platinised titanium anodes were substituted with titanium coated with a coating consisting of tantalum and iridium oxides. The results obtained were as follows:

| | | | |
|---|---|---|---|
| 0 | min | Abs = 0.414 | |
| 30 | min | Abs = 0.352 | 15.0% decomposition |
| 60 | min | Abs = 0.298 | 28.0% decomposition |
| 90 | min | Abs = 0.255 | 38.5% decomposition |
| 120 | min | Abs = 0.217 | 47.6% decomposition |
| 150 | min | Abs = 0.174 | 58.0% decomposition |
| 180 | min | Abs = 0.149 | 64.0% decomposition |

This example illustrates that mixed metal oxide anodes may be utilised for the decomposition of amines.

### Comparative Example 5

### Oxidation of Diethylenetriamine in the Absence of Chloride ions

The method of Example 2 was repeated except that the electrolyte consisted of 5 g/l sodium sulphate with no added chloride and 1 g/l diethylenetriamine.

The results were as follows:

| | | | |
|---|---|---|---|
| 0 | min | Abs = 0.390 | |
| 30 | min | Abs = 0.365 | 6.5% decomposition |
| 60 | min | Abs = 0.348 | 11.0% decomposition |
| 90 | min | Abs = 0.332 | 15.0% decomposition |
| 120 | min | Abs = 0.320 | 18.0% decomposition |
| 150 | min | Abs = 0.308 | 21.0% decomposition |
| 180 | min | Abs = 0.296 | 24.0% decomposition |

It can be seen from the above that in the absence of chloride ions, the rate of decomposition of the diethylenetriamine by electrolysis is much lower (i.e., almost 3× slower) and thus it would take far more time for this method to work and there would be a corresponding cost in energy consumption.

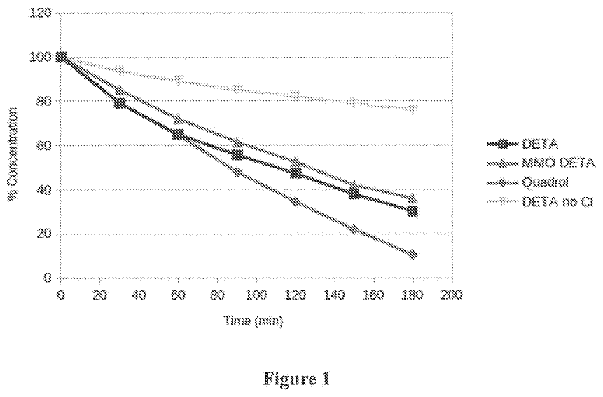

The data from Examples 2, 3 and 4 and Comparative Example 5 are illustrated in FIG. 1. As can be seen in FIG. 1, the concentration of the amine compounds remaining after electrochemical oxidation is much less when the electrochemical oxidation is performed in the presence of chloride than when chloride is omitted from the process.

### Example 6

### Treatment of Industrial Zinc Nickel Waste

A sample of industrial zinc nickel waste was electrolysed using the process described in Example 2. This zinc nickel waste electrolyte contained a 2% dilution of a standard zinc nickel plating electrolyte that included between about 40-50 g/L of the amine complexant (i.e., about 0.8-1.0 g/L of the amine complexant in the 2% dilution).

The chloride content was adjusted to 2000 ppm of chloride ion by adding sodium chloride before commencing the electrolysis. The amount of organic amines present in solution was estimated using the absorbance method shown in Example 2.

The results were as follows:

| | | |
|---|---|---|
| 0 | min | 0% decomposition |
| 30 | min | 25.0% decomposition |
| 60 | min | 38.3% decomposition |
| 90 | min | 52.3% decomposition |
| 120 | min | 65.0% decomposition |
| 150 | min | 73.0% decomposition |
| 180 | min | 80.0% decomposition |

This example illustrates that similar results can be achieved with the electrochemical oxidation of industrial waste containing amine compounds as compared to the results obtained from the oxidation of diethylenetriamine in Examples 1, 2 and 4.

Commercial zinc nickel electrolytes use various amine complexants, which may be used in different concentrations depending on the make-up of the bath and the particular type of complexant. For example, in some instances tetraethylenepentamine may be used in a range of about 1 to about 5 g/L, diethylenetetramine may be used in a range of about 12 to 20 g/L, triethanolamine may be used in arrange of about 2 to 10 g/L, and Quadrol® may be used in a range of about 15 to 25 g/L. Other amine complexants and concentrations of the above complexants may also be used, depending on various factors. It is believed that the process described herein can be used with most amine complexed metals to hydrolyse the amine compound and allow for further treatment of the metal ions.

Thus, the resulting waste stream can be subjected to further treatment to precipitate zinc and nickel ions, such as by hydroxide precipitation. The resulting waste stream will thus contain levels of zinc and nickel (or other metals) below regulated levels and thus suitable for discharge.

What is claimed is:

1. A process of treating a waste stream comprising organic amine compounds complexed with heavy metal ions, the process comprising the steps of:
a) adjusting the pH of the waste stream to between about 4 and about 10;
b) adding a chloride salt to the waste stream to produce a concentration of chloride ions in the waste stream:
c) circulating the waste stream through an electrochemical reactor, wherein the electrochemical reactor comprises an array of electrodes comprising alternating anodes and cathodes, wherein the waste stream is circulated through the electrochemical reactor for a period of 30 to 180 minutes to hydrolyse amine compounds; and thereafter
d) removing heavy metal ions from the waste stream.

2. The process of claim 1, wherein the pH of step a) is between 8 and 9.2.

3. The process of claim 1, wherein the chloride salt is selected from the group consisting of sodium chloride and potassium chloride.

4. The process of claim 1, wherein the concentration of chloride ions in the waste stream is between about 10 and about 50,000 mg/L.

5. The process of claim 4, wherein the concentration of chloride ions in the waste stream is between about 600 and about 1,200 mg/L.

6. The process according to claim 1, wherein the heavy metal ions are selected from the group consisting of nickel, zinc, copper and combinations of one or more of the foregoing.

7. The process according to claim 1, wherein the anodes are selected from the group consisting of titanium or niobium coated with platinum or mixed metal oxides; a combination of one or more of iridium oxide, ruthenium oxide and tantalum; lead oxide; graphite; and boron doped diamond.

8. The process according to claim 1, wherein the cathodes are selected from the group consisting of mild steel and stainless steel.

9. The process according to claim 1 wherein the array of electrodes is arranged so that the distance between adjacent anodes and cathodes is between about 0.5 and about 20 cm.

10. The process according to claim 1, wherein the amine compounds are selected from the group consisting of ethylenediamine, diethylenetriamine, triethylenetetramine, tetraethylenepentamine, and pentaethylenehexamine: alkylene oxide adducts such as ethylene oxide adducts and propylene oxide adducts of the above alkylene amines; aminoalcohols such as ethanolamine, diethanolamine. triethanolamine, diisopropanolamine, triisopropanolamine, ethylenediamine tetra-2-propanol, N-(2-aminoethyl)ethanolamine, and 2-hydroxyethylaminopropylamine; alkanolamine compounds such as N-(2-hydroxyethyl)-N,N′,N′-triethylethylenediamine, N,N′-di(2-hydroxyethyl)-N,N′-diethylethylenediamine, N,N,N′,N′-tetrakis(2-hydroxyethyl)propylenediamine, N,N,N′,N′-tetrakis(2-hydroxypropyl)ethylenediamine; poly(alkylene imine)s obtained from ethylene imine, 1,2-propylene imine: poly(alkylene amine)s obtained from ethylene diamine, triethylene tetramine; ethylenediamine tetraacetic acid, and combinations of one or more of the foregoing.

11. The method according to claim 1, wherein the step of circulating the waste stream through the electrochemical reactor hydrolyses any cyanide compounds in the waste stream.
